(19) United States
(12) Patent Application Publication
(10) Pub. No.: US 2026/0003340 A1
(43) Pub. Date: Jan. 1, 2026

(54) METHOD FOR GENERATING A CONTROL DATA SET FOR ADDITIVE MANUFACTURING, AND METHOD AND APPARATUS FOR ADDITIVE MANUFACTURING

(71) Applicant: GROB-WERKE GmbH & Co. KG, MINDELHEIM (DE)

(72) Inventors: Martin OTTER, MEMMINGEN (DE); Oliver LEUSCH, AUGSBURG (DE); Maximilian DROPMANN, KAUFBEUREN (DE); Johannes GLASSCHRÖDER, NEUSÄSS (DE); Christian MIKLEC, BAD WÖRISHOFEN (DE); Andreas LANG, ETTRINGEN (DE); Emanuel ENGELSBERGER, SONTHEIM (DE); Matthias SCHWEIGER, MAUERSTETTEN (DE)

(21) Appl. No.: 19/250,777

(22) Filed: Jun. 26, 2025

(30) Foreign Application Priority Data
Jun. 28, 2024 (EP) 24185485.0

(51) Int. Cl. G05B 19/4099; B22F 10/22; B22F 10/85; B22F 12/90; B33Y 10/00; B33Y 30/00; B33Y 50/02

(52) U.S. Cl. CPC G05B 19/4099; B22F 10/22; B22F 10/85; B22F 12/90; B33Y 10/00; B33Y 30/00; B33Y 50/02; B22F 2998/10; G05B 2219/49023

(57) ABSTRACT

A method for generating a control data set for additive manufacturing components whose wall thickness can vary over the component height using a drop-based method, in which for each layer, first a theoretical number xₜₕ of paths is calculated from the quotient between the layer width s and a predetermined target line spacing dL_{O}, this theoretical number is rounded up to the next higher natural number and rounded down to the next lower natural number, then data sets with the rounded-up and rounded-down numbers are generated, and these data sets for the rounded-down number and the rounded-up number are compared with predetermined target values depending on the component. One of the data sets is then selected as the control data set based on this comparison.

### CROSS-REFERENCES TO RELATED APPLICATIONS

This application claims the benefit of European Patent Application Number 24185485.0 filed on Jun. 28, 2024, the entire disclosure of which is incorporated herein by way of reference.

### FIELD OF THE INVENTION

The invention relates to a computer-implemented method for generating a control data set for controlling a print head in drop-based additive manufacturing of a component. The invention further relates to a method for additive layer-by-layer manufacturing of a component, in which a control data set generated in this way is used. The invention further relates to a data processing device configured to carry out such a method for generating control data sets, a computer program with instructions for carrying out the method for generating, a controller for a device for additive manufacturing, and a device for additive manufacturing equipped with such a controller.

The invention lies in the field of additive manufacturing and, in particular, in the field of drop-based additive manufacturing. Preferred embodiments relate to computer-implemented methods and corresponding computer programs for generating control data sets with which the additive manufacturing method is controlled. Such computer programs are also referred to as “slicers.”

### BACKGROUND OF THE INVENTION

For the technological background, reference is made to the following literature:
[1] DE 10 2019 128 068 A1
[2] DE 10 2020 104 296 A1
[3] DE 10 2021 115 821 A1
[4] DE 10 2021 116 623 A1
[5] DE 10 2021 117 285 A1
[6] WO 2022/161764 A1
[7] EP 3 556 543 B1
[8] WO 2020/198038 A1
[9] EP 4 282 560 A1
[10] EP 3 800 539 A1

References [1] to [6] relate to devices and methods for additive manufacturing, in particular for drop-based additive manufacturing, and provide details thereof. In particular, reference [6] describes methods and devices for the layer-by-layer production of components. In addition to the basics of additive manufacturing systems that are particularly well suited for use in embodiments of the invention, it also discusses the general strategies of the slicer in detail.

Reference [7] describes a basic approach of a slicer for an inkjet process for calculating the drop positions for the layer-by-layer production of its component. Reference [8] describes a best-fit strategy for path calculation in a drop-based 3D printing process. Reference [9] describes a method in which a gain map of the component surface is calculated from measured information from an optical measuring system and an offset is calculated with which components with overhang are printed. Reference provides a compensation method. An optical measuring system is used to record the ACTUAL geometry of the component during the printing process and compare it with a TARGET geometry. This allows local defects to be detected and compensated for by adjusting the process parameters.

The problem with previous drop-based additive manufacturing processes is that components with variable layer thicknesses over the component height, especially those with overhang features, can only be printed with greater effort, e.g., using support structures, or with a loss of quality.

### SUMMARY OF THE INVENTION

The object of the invention is to provide possibilities for manufacturing components with overhang features or other variable layer thicknesses over the component height, but also components with uniform layer thickness, in high quality and at low economic cost in drop-based additive manufacturing.

This object may be achieved by a computer-implemented method for generating a control data set for controlling a print head according to one or more embodiments described herein, a method for additive manufacturing using such a control data set generation method, a data processing device configured to carry out the control data set generation method, a corresponding computer program and a correspondingly configured controller.

According to one aspect, the invention provides a computer-implemented method for generating a control data set for controlling a print head in drop-based additive manufacturing of a component which has a wall thickness that can vary over the component height, so that each layer of the component to be additively manufactured has a layer width s, wherein the control data set for each layer contains a drop spacing dT, with which drops are ejected along lines in drop-based additive manufacturing with a drop diameter D, a line spacing dL, which indicates the spacing of the lines, and a layer height dZ, comprising the steps of:
a) calculating a theoretical number xₜₕ of paths from the quotient between the layer width s and a predetermined target line spacing dL_{O} using

$${x}_{th} = \frac{s}{{dL}_{O}} ,$$

followed by rounding up the value xₜₕ to the next higher natural number to obtain a rounded-up number x_{auf}, and rounding down the value of the quotient to the nearest lower natural number, to obtain a rounded-down number x_{ab};
b) calculating a first data set of line spacing dL, drop spacing dT, and layer thickness dZ based on the rounded-up number x_{auf},
c) calculating a second data set of line spacing dL, drop spacing dT and layer thickness dZ based on the rounded-down value x_{ab}, and
d) comparing the values of the first and second data sets with predetermined target values dL_{O}, dT_{O}, and dZ_{O} depending on the component and selecting the first or second data set as the control data set based on this comparison.

In some embodiments, it is provided that the line spacing is calculated using

$${dL}_{suf} = \frac{s}{{x}_{suf}} ,$$

where the suffix suf stands for “up” for the first data set and “down” for the second data set.

In some embodiments, it is provided that the drop spacing is calculated using dT_{suf}=kTL−dL_{suf}, where kTL is a predetermined constant.

In some embodiments, it is provided that the layer thickness dZ is a predetermined constant value.

In some embodiments, it is provided that the layer thickness dZ is determined from the relationship dZ_{suf}×dT_{suf}×dL_{suf}=C, where C is a predetermined constant.

In some embodiments, step d) includes:
d1) selection of the data set whose sum of the amounts of deviations from the predetermined target values is minimal.

The values of the control data set can be calculated or specified in any form suitable for controlling additive manufacturing, in particular for moving the print head. For example, they can be specified as absolute values with a length dimension in the respective coordinate system of the production plant. In particular, it has proven advantageous to specify the values normalized to the respective drop diameter D. In some embodiments, it is therefore provided that the values dZ, dT, and dL are calculated as factors, with absolute values being obtained by multiplication with the drop diameter D. In particular, the target values can also be specified as factors to be multiplied by the drop diameter D. In some embodiments, which will be explained in more detail below, dL₀ is specified as the product of “optimal dL*drop diameter D.”

In some embodiments in which the values are specified as values normalized to the drop diameter D, it is provided that

$$C = \frac{π}{6}$$

applies.

In some embodiments, the drop diameter D is a predetermined constant drop diameter.

In some embodiments, the drop diameter D is variable.

In some embodiments, the drop diameter D is variably selected from a first drop diameter and a second drop diameter that differs from the first drop diameter.

In some embodiments, it is provided that the layer thickness dZ is calculated depending on the variable drop diameter.

According to a further aspect, the invention provides a method for the additive layer-by-layer manufacturing of a component having a wall thickness that can vary over the component height by dropwise application of a liquid material by means of a print head, the method comprising:
generating control data sets for layers of the component by means of a method according to one of the preceding embodiments and controlling the print head by means of the generated control data sets.

According to a further aspect, the invention provides a data processing device comprising means for carrying out the method for generating control data sets according to one of the preceding embodiments.

According to a further aspect, the invention provides a computer program comprising instructions which, when executed by a computer, cause the computer to execute the method for generating control data sets according to one of the preceding embodiments.

According to a further aspect, the invention provides a computer-implemented controller for a device for additive manufacturing of a component, which controller comprises a print head for dropwise application of liquid material and a movement mechanism for relative movement of the print head and the component to be manufactured, wherein the controller is designed to control the device for carrying out the additive manufacturing process according to one of the above configurations.

In particular, the controller has a processor and a memory in which the computer program according to the configuration explained above is stored.

According to a further aspect, the invention provides a device for the additive manufacturing of a component, the device comprising a print head for the drop-by-drop application of liquid material, a movement mechanism for the relative movement of the print head and the component to be manufactured, and a controller which is designed to control the device for carrying out the additive manufacturing process according to the above configuration. In particular, the controller is designed in accordance with the aforementioned configuration.

Advantageous designs of the invention relate to a “dynamic skin” method for calculating the path of the printing process for additively manufactured components.

In particular, advantageous embodiments of the invention provide a “dynamic skin” method which describes a calculation basis for path calculation for 3D printing systems with a drop-based printing method used in the additive manufacturing of components with variable wall thickness.

Some embodiments relate to a method for calculating the path movement for the additive manufacturing of a component with thin-walled geometries or surfaces with downskin or upskin using a drop-based process by means of a print head with the following procedure:
calculation of a theoretical number of paths from the quotient between the radial layer width and the optimal line spacing, followed by rounding up and rounding down of this value,

calculation of a real line spacing dL in each case from these two results,
calculation of a drop spacing dT in each case according to the principle
   the sum of the factors drop spacing dT and line spacing dL results in a constant value,
calculation of a layer height dZ in each case, which multiplied by the two factors drop spacing dT and line spacing dL results in a constant value,
with a final case-by-case decision in which the sum of the deviations of the respective calculated factors of the case to be selected is minimal.

In some embodiments of the method, the layer height dZ and the drop diameter D are constant.

In some embodiments of the method, the drop diameter D can be varied within a range around the value of a predetermined drop diameter Do.

Further independent claim:

In some embodiments of the method, the drop diameter D can assume a second value of the drop diameter that differs from the first value in addition to a first value of the drop diameter.

In some embodiments of the method, the layer height dZ is calculated variably in combination with the drop diameter D.

In some embodiments of the method, the decision is made on the basis of a different mathematical relationship.

### BRIEF DESCRIPTION OF THE DRAWINGS

Examples of embodiments are explained in more detail below with reference to the accompanying drawings.

FIG. 1 shows a schematic block diagram of an additive manufacturing device in which a component is manufactured layer by layer using a print head;

FIG. 2 shows a schematic plan view of a build platform of the device of FIG. 1, on which discharges of drops along lines at three different drop intervals dT are shown next to each other;

FIG. 3 shows a schematic plan view similar to FIG. 2, in which several such line paths are shown next to each other with the same drop spacing but with three different line spacings dL;

FIG. 4 shows a schematic side view of a detail of the component currently being manufactured, in which manufacturing processes with different layer thicknesses dZ are shown next to each other;

FIG. 5 shows a plan view of the build platform during the manufacturing of the component, with conventional manufacturing without skin shown on the left and manufacturing with skin shown on the right;

FIG. 6 shows a section through an example component to be produced;

FIG. 7 shows a schematic sectional view of the component from FIG. 6, in which drop deposits are shown according to a previous deposition strategy;

FIG. 8 shows a flow chart for a method of generating a control data set for controlling the print head for a deposition strategy according to an embodiment of the invention;

FIG. 9 a shows representation as in FIG. 7, wherein the drop deposition has been carried out using the control data set generated according to the method; and

FIG. 10 shows a representation as in FIG. 7 for a further example of a shape for a component whose production can be improved using the new deposition strategy.

### DETAILED DESCRIPTION OF THE PREFERRED EMBODIMENTS

The following describes in more detail methods and devices for additive manufacturing, as well as computer-implemented methods for generating control data sets for this purpose and a device for data processing and a control device for this purpose according to embodiments of the invention, with reference to the accompanying drawings.

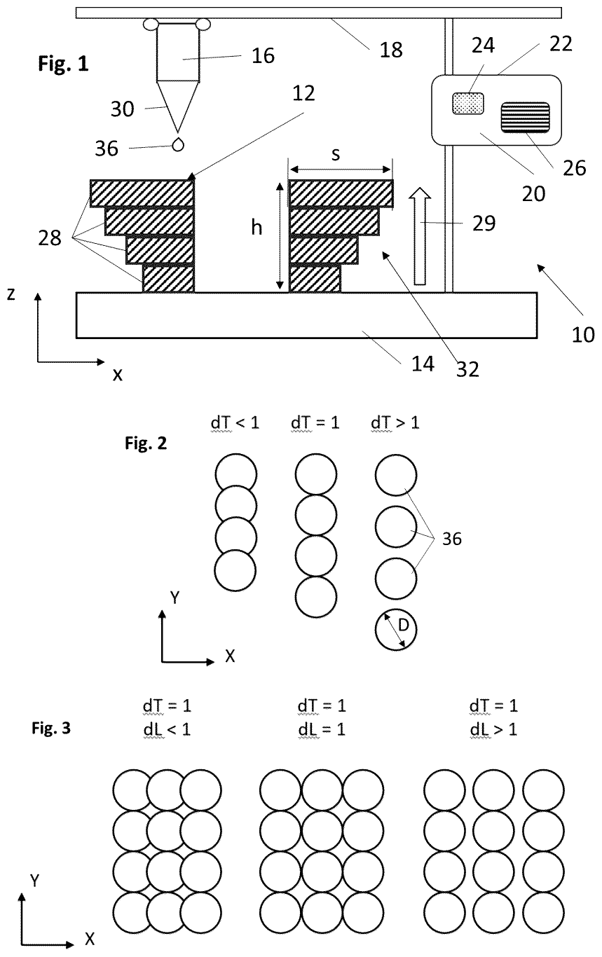

FIG. 1 schematically shows a device 10 for drop-based additive manufacturing of a component 12, wherein the device 10 has a build platform 14, a print head 16 for dropwise application of liquid material, a movement mechanism 18 for the relative movement of the print head 16 and the build platform and thus of the component 12 to be manufactured, and a controller 20 for controlling the relative movement and the drop discharge of the print head 16 on the basis of control data sets. The computer-implemented controller 20 is designed as a data processing device 22 with a processor 24 and a memory 26 in which at least one computer program (known as a “slicer”) for controlling and generating control data sets is stored.

Using the drop-based additive manufacturing process to be carried out on the device 10, three-dimensional components 12 are built up layer by layer in a manner known in principle; the multiple layers 28 are shown schematically in FIG. 1. In FIG. 1, the build direction 29 is the z-direction, and the print head 16 and the build platform 14 are moved relative to each other in one layer in the x-y plane and in the z-plane during the transition from one layer 28 to the next. In principle, it is possible for the print head 16 to be moved while the build platform 14 remains stationary, or vice versa, for the build platform 14 to be moved while the print head 16 remains stationary, or for both to be moved. A corresponding manufacturing technique and details of the device 10 are known to those skilled in the art, in particular from references [1] to [6], so that they are not described further at this point.

Additive manufacturing has been experiencing strong growth in all areas for a long time. In addition to the steadily increasing number of suppliers, subcontractors, and service providers, the fields of application are expanding due to continuously improving process quality and the resulting increase in component complexity and size. Each of these different 3D printing processes requires software that calculates a process-specific axis movement (for the x, y, and z axes) from the 3D model of a component to be manufactured using additive manufacturing. This so-called “slicer” calculates, for example, in a “laser powder bed” process not discussed here, how the mirror that deflects the laser must be moved, which laser in turn is responsible for melting the powder. The slicer of a “metal fused deposition modeling” system calculates the path that the nozzle travels in order to build up the intended component using the filament fed at a defined feed rate.

The slicer is therefore a software solution that is responsible for calculating multiple axis movements for the additive manufacturing of components 12 of different levels of complexity, taking into account the process characteristics of a 3D printing process. The aim is to achieve the highest possible component quality, which is defined by criteria such as surface quality, structural homogeneity, density, mechanical properties, etc.

Sooner or later, every 3D printing process reaches its limits, beyond which components can no longer be produced with the existing system technology in combination with the software version due to excessive complexity.

Embodiments of the invention relate to drop-based 3D printing processes. A drop-based 3D printing process according to embodiments of the invention, whose drop diameter can be adjusted in the range of, for example, 100 μm to 3000 μm by process adaptation, can take this high variability into account during slicing and thus logically has more potential for the production of different component geometries.

In contrast, a drop-based 3D printing process, in which the process characteristics allow a drop variation of only +−10 μm, i.e., for example 490 μm to 510 μm, reaches its limits earlier with the same slicer.

One objective of some embodiments of the invention is therefore to enable the slicer to expand limited application possibilities by extending the calculation strategies.

It may be the case that the drop diameter of a drop-based 3D printing process can only be varied with great effort, or that the reliability of the drop variation is not sufficiently reliable due to disruptive influences. In addition to the drop diameter, innovative slicers already in use have a variety of integrated parameters that make this possible.

The following presents a solution that uses these parameters to expand the field of application for potentially printable component geometries of a 3D printing process with limited possibilities in the variation of the drop diameter.

Embodiments of the invention are based on a liquid metal printing process developed by the applicant called “Grob Metal Printing,” abbreviated “GMP,” details of which are described and shown in [1] to [6]. This wire-based 3D printing process generates liquid drops 36 with defined properties from a nozzle 30, which drops are deposited on the build platform 14. The slicer, which is available for this purpose as a computer program in the control system 20, knows when a drop 36 is ejected and calculates the movements of the X, Y, and Z axes that ensure that the desired components 12 are built up layer by layer. In the basic deposition strategy of preferred embodiments of this slicer, a factor is defined for the drop spacing dT, the line spacing dL, and the layer thickness dZ. These factors are in each case multiplied by the existing drop diameter D to calculate the absolute value. The following explains the method for generating control data sets based on the parameter values dT, dL, and dZ as such factors of the drop diameter D. Of course, in other embodiments, the parameters can also be specified in other ways, e.g., as absolute values, e.g., in mm or μm.

FIG. 2 shows a plan view of the build platform 14 with drops deposited along three lines, wherein the drops with a drop spacing dT<1 are deposited in the left line, drops with a spacing dT=1 in the middle line, and drops with a drop spacing dT<1 in the right line, in order to illustrate the effect of changing the drop spacing dT.

FIG. 3 shows a plan view of the build platform 14, wherein, to illustrate the effect of a change in the line spacing dL, a build-up of a layer by drop deposition along lines with a drop spacing dT=1 is shown on the left, wherein the lines are deposited next to each other with a line spacing of dL<1. In the middle, the build-up of a layer by drop deposition along lines with a drop spacing dT=1 is shown, wherein the lines are deposited next to each other with a line spacing of dL=1. On the right, the build-up of a layer by drop deposition along lines with a drop spacing dT=1 is shown, wherein the lines are deposited next to each other with a line spacing of dL>1.

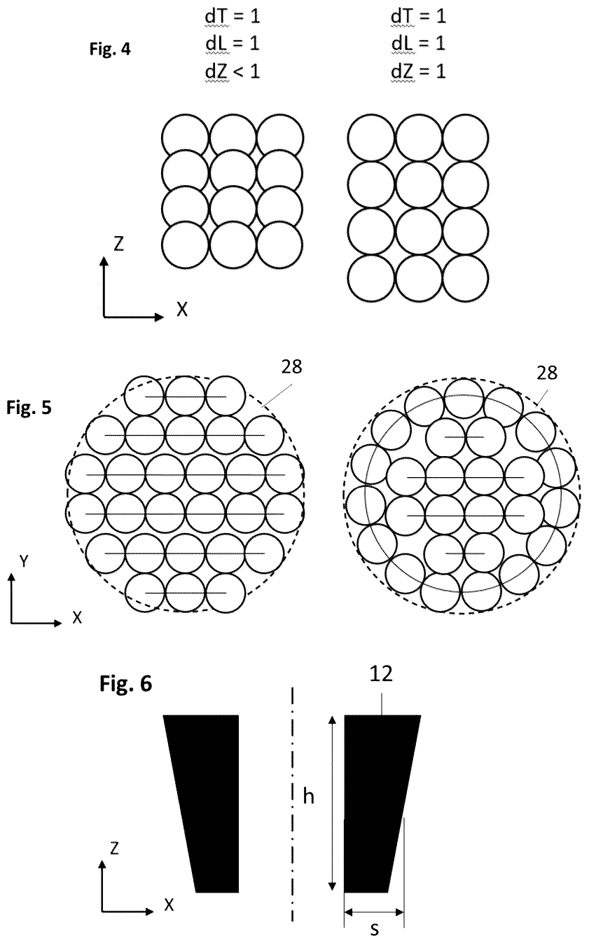

FIG. 4 shows a schematic side view of components according to a simplified model, wherein layers with a layer thickness dZ<1 have been deposited in a component shown on the left and layers with a layer thickness dZ=1 have been deposited in a component shown on the right.

With this deposition strategy for liquid drops with constant values dT, dL, and dZ shown in FIGS. 2 to 4, components with low complexity can already be printed. A component produced using the parameter set dT=dL=dZ=1 will not meet the requirements of the desired geometry in most cases, as it will not reach the component height and/or will have a very low component density. In a simplified model, it is approximated that the spherical drop solidifies as a voxel when it hits the component surface. The formation of pores is prevented and the required component height is achieved if the voxel volume, i.e., the product of dT*drop diameter D, dL*drop diameter D, and dZ*drop diameter D, is adjusted to the volume of the drop V=4/3*r³*pi as follows.

$$\frac{4}{3} * {( \frac{D}{2} )}^{3} * π = ( dT * D ) * ( dL * D ) * ( dZ * D )$$

This results in

$$dT * dL * dZ = \frac{π}{6} = 0.5236$$

In order to be able to represent higher complexities, the slicer is extended by further features and strategies in embodiments of the invention.

According to reference [6], for example, printing one or more skins, i.e., depositing one or more drop lines on the outer contour of the layer to be printed, greatly improves the surface properties of the resulting component, as shown in FIG. 5. On the left, the build-up of a layer by simply depositing lines next to each other is shown there, where dT=1 and dL=1 and the number of skins=0. On the right, the build-up of a layer is shown where lines are deposited next to each other in the core and one line is deposited along the outer contour, so that dT=1, dL=1 and the number of skins=1.

Using the GMP technology according to the current state of the art as described in [1] to [6], overhangs of up to 45° can currently be printed as thin structures with a constant wall thickness starting at 2*drop diameter. Furthermore, there are geometries, such as overhangs greater than 45°, which can only be realized with a workaround-in this case, by using support structures. There is currently no solution for printing a geometry with variable wall thickness over Z without loss of quality.

Embodiments of the invention relate to a novel slicer strategy that is particularly applicable to components 12 which, as shown in FIG. 6, have a variable wall thickness s over the component height h, especially in overhang areas 32. However, the embodiments of the invention are also suitable for printing components with a constant wall thickness s, as before. They can be used where the wall thickness s may or may not vary over the component height.

In order to print components of the type shown in FIG. 6 using drop-based 3D printing, a trivial solution would be to vary the drop diameter D in such a way that the radial layer width s is completely filled by a natural number of drops at all times. However, very few 3D printing processes are capable of varying the drop diameter to such a large extent. In the processes known from the above literature, this approach involves such a great deal of effort that the processes become uneconomical.

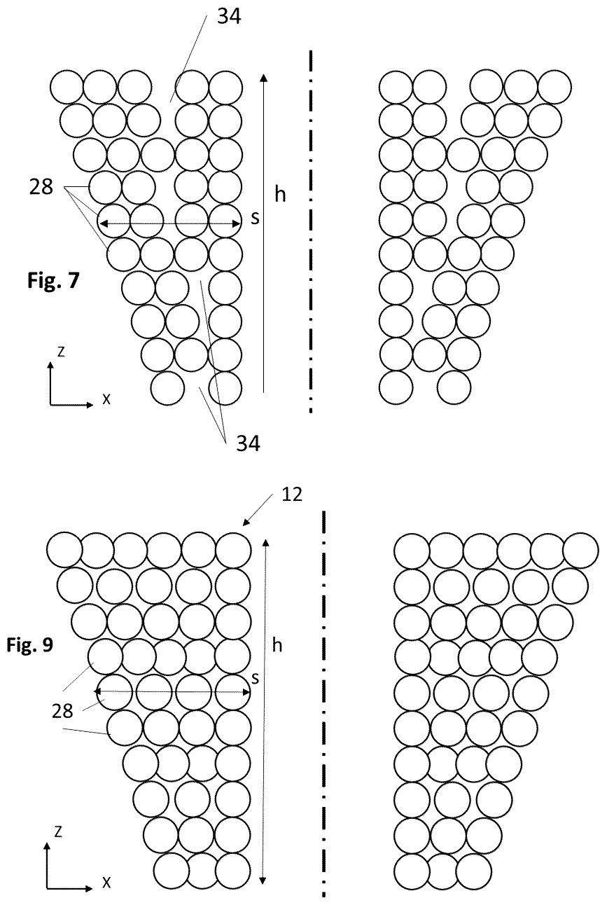

FIG. 7 shows how the geometries described above and illustrated in FIG. 6 as examples are sliced according to the current state of the art when it is not possible to vary the drop diameter. Regular gaps 34 in the sliced model lead to increasing unevenness on the component surface during the printing process. In addition to the fact that the target geometry of component 12 cannot be achieved without further compensation, the drops of the following layers do not land in the calculated destinations due to the uneven surface. A component analysis of a component printed in this way will in all probability show an increased pore content in addition to the geometric deviation.

In contrast, in particularly preferred embodiments of the invention, it is intended to print this component 12 with an overhang and variable wall thickness s above the component height exclusively in skin layers, in which dT, dL, and dZ are calculated dynamically in such a way that a flat, gap-free drop layer is formed.

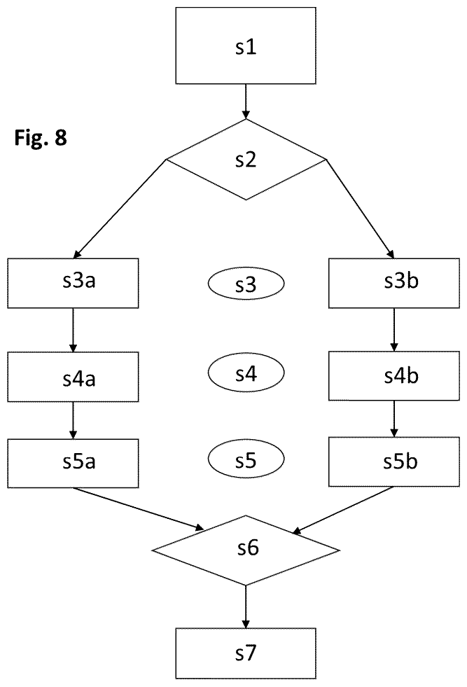

FIG. 8 shows a flow chart illustrating the slicer's procedure for calculating an NC code and thus an example of a method for generating control data sets for the relative movement of print head 16 and component 12. The labeling in the flow chart means:
s1 given variables:
   wall thickness/layer width s
   drop diameter D
   optimal target drop spacing dTₒₚₜ
   optimal line spacing dLₒₚₜ
   optimal layer thickness dZₒₚₜ
   drop-line-constant kTL
s2 calculation of theoretical number of lines xₜₕ:

$${x}_{th} = \frac{s}{dLopt * D}$$

s3 x [symbol] EN
s3a calculation of dL_{ab} with rounded-down number of lines x_{ab}:

$${dL}_{ab} = \frac{s}{{x}_{ab} * D}$$

s3b calculation of dL_{auf} with rounded-up number of lines x_{auf}:

$${dL}_{auf} = \frac{s}{{x}_{auf} * D}$$

s4

$$dT + dL = kTL$$

s4a calculation of dT_{ab} with rounded-down number of lines x_{ab}:

$${dT}_{ab} = kTL - {dL}_{ab}$$

s4b calculation of dT_{auf} with rounded-up number of lines x_{auf}:

$${dT}_{auf} = kTL - {dL}_{auf}$$

s5

$$dT * dL * dZ = \frac{π}{6}$$

s5a calculation of dZ_{ab} with rounded-down number of lines x_{ab}:

$${dZ}_{ab} = \frac{π}{6 * {dT}_{ab} * {dL}_{ab}}$$

s5b calculation of dZ_{auf} with rounded-up number of lines x_{auf}:

$${dZ}_{auf} = \frac{π}{6 * {dT}_{auf} * {dL}_{auf}}$$

s6 case-by-case decision:

$$\vert dL - dLopt \vert + \vert dT - dTopt \vert + \vert dZ - dZopt \vert = min .$$

s7 result:
   drop spacing dT
   line spacing dL
   layer height dZ

According to step s1, the drop diameter D, the (radial) layer width s of a thin-walled area with down or up skin of a component 12 to be printed, and the optimum target values for drop spacing dTₒₚₜ, line spacing dLₒₚₜ, and layer thickness dZₒₚₜ are given. These optimal values are defined by the fact that they lie in the middle of a range of values whose values fully meet the requirements placed on component 12. The optimal values depend on the material properties of the printing material, such as the solidification interval or viscosity, and must be determined individually for each printing material. If the deviation of a factor from its optimum value is too great, this can lead to a reduction in the mechanical properties of the component.

Fictitious example: Preliminary tests have determined that one can vary the drop spacing dT in the range from 1.4 to 0.6 without impairing the quality of the printed component 12. The optimal drop spacing is in the middle of the range, i.e., at dTₒₚₜ=1.0, as the drop spacing can increase or decrease by 0.4 from this value. If printing is carried out with a drop spacing dT of more than 1.4 or less than 0.6, for example 1.5 or 0.5, pores form between the individual drops, which impairs mechanical properties such as tensile strength or elongation at break. In addition, the geometry of the printed component is not maintained.

In addition to the optimal values, there is a so-called drop line constant kTL, which should also be determined individually for each material composition of the printing material in basic tests. The drop spacing cannot be varied easily with any line spacing. If the drop spacing and line spacing increase simultaneously, a point is reached where pores form and the quality of the printed component 12 no longer meets the requirements. The drop-line constant kTL is the result of the sum of the drop spacing dT and the line spacing dL.

In step s2, a theoretical number xₜₕ of paths is calculated from the quotient between the layer width s and a predetermined target line spacing dL_{O} using

$${x}_{th} = \frac{s}{{dL}_{O}} .$$

The target line spacing dL₀ specifies the optimum target line spacing as specified by the wall thickness s. If the wall thickness s is specified as an absolute value in mm or μm, for example, then the absolute value is also specified for the target line spacing. In our examples above, where dT, dL, and dZ are specified as factors of the drop diameter D, dLₒ=dLₒₚₜ*D must then be entered.

The value xₜₕ is then rounded up to the next higher natural number to obtain a rounded number xᵤₚ, and the value of the quotient is rounded down to the next lower natural number to obtain a rounded number x_{down}.

Then, in branch b) of the flowchart in FIG. 8, a first data set of line spacing dL, drop spacing dT, and layer thickness dZ is calculated based on the number rounded up x_{auf}.

In branch a) of the flowchart in FIG. 8, a second data set of line spacing dL, drop spacing dT, and layer thickness dZ is calculated based on the value rounded down x_{ab}.

The values of the first and second data sets are then compared with the optimum target values dLₒₚₜ, dTₒₚₜ and dZₒₚₜ predetermined for the component, and a control data set is selected from the first or second data set based on this comparison.

The example shown in FIG. 8 of determining the control data sets is explained in more detail below. Accordingly, in a first calculation in step s2, the layer width s is divided by the product “optimal dLₒₚₜ*drop diameter D”; for example, a wall with s=4.5*D is divided by “1*D” with an optimal dLₒₚₜ of 1. The result of this calculation is the theoretical line number xₜₕ. Since the layer width s can only be applied by a natural number of skins, the result is rounded up or down in the next step, resulting in the two values 4 and 5 in our example (xₜₕ=4.5). If the result of this calculation is an integer, this value is used for further calculations and no further case by case decision is necessary. If this does not happen, the factors dT and dZ are calculated for both cases a) rounded down and b) rounded up in the next steps.

Then, in steps s3, s3a, s3b, the rounded-down or rounded-up line number x_{ab} or x_{auf} is used to calculate back to a real dL_{ab} or dL_{auf} for each case using the formula described in s2.

In steps s4, s4a, s4b, a corresponding drop spacing dT_{ab} or dT_{auf} is determined using the condition “drop spacing dT+line spacing dL=drop-line constant kTL.”

Under the further condition that the product of the drop spacing dT, the line spacing dL, and the layer height dZ must correspond to the value “π/6,” a layer height dZ_{ab} or dZ_{auf} is obtained in steps s5, s5a, s5b.

In a case-by-case decision, in step s6, the factors dT_{ab}, dL_{ab}, and dZ_{ab}, whose values have been determined from the rounded-up line number x_{ab}, are compared with the values of the factors dT_{auf}, dL_{auf}, and dZ_{auf}, which have been determined from the rounded-up line number x_{auf}. The case is decided in favor of the option whose sum of the three amounts between the respective factor and its optimal value is smaller. A parameter combination in which the calculated values for dT, dL, and dZ deviate by only 0.1 up or down from their optimal values is preferred to a parameter combination whose calculated values for dT, dL, and dZ deviate by 0.2 up or down from their optimal values.

In some embodiments, particularly those where the drop generation process still needs to be optimized, the slicer does not allow any change in the drop diameter D, i.e., the drop diameter remains constant in these embodiments. In other embodiments, the drop diameter D can also be varied, e.g., in a small range or by selection from a small number of predetermined drop diameters.

FIG. 9 shows a schematic, greatly simplified cross-section through the drop-based 3D-printed component 12 of the shape shown as an example in FIG. 6, which was produced using the slicer according to embodiments of the invention. Ten layers were produced, the control data sets for which are shown in the following Table 1.

TABLE 1

| | Number | | | |
|---|---|---|---|---|
| Layer | of skins | dT | dL | dZ |
| 10 | 6 | 0.86 | 0.94 | 0.65 |
| 9 | 5 | 0.73 | 1.07 | 0.67 |
| 8 | 5 | 0.80 | 1.00 | 0.65 |
| 7 | 5 | 0.87 | 0.93 | 0.65 |
| 6 | 4 | 0.72 | 1.08 | 0.67 |
| 5 | 4 | 0.80 | 1.00 | 0.65 |
| 4 | 4 | 0.88 | 0.92 | 0.65 |
| 3 | 3 | 0.69 | 1.11 | 0.68 |
| 2 | 3 | 0.80 | 1.00 | 0.65 |
| 1 | 3 | 0.91 | 0.89 | 0.65 |

The strategy according to preferred embodiments of the invention is particularly suitable for small upskins or downskins up to approximately 30°, since here the jump from n skins to n+1 skins takes place over sometimes significantly more than two layers.

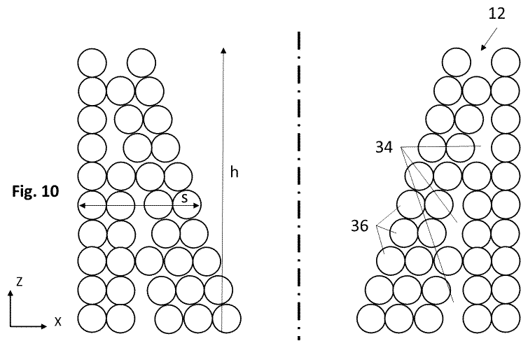

The following section explains the advantages of some embodiments of the invention that have been confirmed by tests:
1. Using the method for generating control data sets according to embodiments of the invention results in a plane and gap-free drop layer. Without adjusting the control data of the “dynamic skin,” the previous slicer calculates gaps inside the component. This problem can be solved by varying the slice factors drop spacing dT, line spacing dL, and layer height dZ. The dynamic adjustment of these three factors leads to an optimal volume distribution of the deposited drops and thus to a component surface that is plane after each layer. This ensures that the drops of the following layer land at the calculated positions.
2. Another advantage of the new calculation strategy is that it can be used not only for downskin but also for upskin of thin-walled parts. FIG. 10 shows an example of such a component that has been 3D-printed using previous slicers based on drops. Here, too, gaps 34 are created. Especially with small upskin angles, adjusting the control data sets according to the embodiments of the invention prevents the formation of uneven layers due to gaps in individual layers. Comparable to FIG. 9, the free spaces 34 can also be avoided in components 12 of the type shown in FIG. 10.

A “Dynamic Skin” method has thus been described, which, as a method for generating control data sets, describes a calculation basis for path calculation for 3D printing systems with a drop-based printing method that is used in the additive manufacturing of components 12 with potentially variable wall thickness s.

In order to be able to additively manufacture components 12, whose wall thickness can vary more greatly over the component height, with high quality and at low cost using a drop-based method, a computer-implemented method for generating a control data set for each layer is proposed, wherein first a theoretical number xₜₕ of paths is calculated from the quotient between the layer width s and a predetermined target line spacing dL_{O}, this theoretical number is rounded up to the next higher natural number and rounded down to the next lower natural number, then data sets with the rounded-up and rounded-down numbers are generated, and these data sets for the rounded-down number and the rounded-up number are compared with predetermined target values depending on the component. One of the data sets is then selected as the control data set based on this comparison.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SYMBOLS

10 device for additive manufacturing
12 component
14 build platform
16 print head
18 movement mechanism
20 controller
22 device for data processing
24 processor
26 memory
28 layer
29 direction of construction
30 nozzle
32 overhang area
34 free space
36 drop
S wall thickness
s1 given dimensions:
   wall thickness/layer width s
   drop diameter D
   optimal target drop spacing dTₒₚₜ
   optimal line spacing dLₒₚₜ
   optimal layer thickness dZₒₚₜ
   drop-line constant kTL
s2 calculation of theoretical line number xₜₕ:

$${x}_{th} = \frac{s}{dLopt * D}$$

s3 x [symbol] N
s3a calculation of dL_{ab} with rounded-down line number x_{ab}:

$${dL}_{ab} = \frac{s}{{x}_{ab} * D}$$

s3b calculation of dL_{auf} with rounded-up line number x_{auf}:

$${dL}_{auf} = \frac{s}{{x}_{auf} * D}$$

s4

$$dT + dL = kTL$$

s4a calculation of dT_{ab} with rounded-down line number x_{ab}:

$${dT}_{ab} = kTL - {dL}_{ab}$$

s4b calculation of dT_{auf} with rounded-up line number x_{auf}:

$${dT}_{auf} = kTL - {dL}_{auf}$$

s5

$$dT * dL * dZ = \frac{π}{6}$$

s5a calculation of dZ_{ab} with rounded-down line number x_{ab}:

$${dZ}_{ab} = \frac{π}{6 * {dT}_{ab} * {dL}_{ab}}$$

s5b calculation of dZ_{auf} with rounded-up line number x_{ab}:

$${dZ}_{auf} = \frac{π}{6 * {dT}_{auf} * {dL}_{auf}}$$

s6 case-by-case decision:

$$\vert dL - dLo \vert + \vert dT - dTo \vert + \vert dZ - dZo \vert = min ,$$

s7 result:
   drop spacing dT
   line spacing dL
   layer height dZ
h component height

Claimed is:

1. A method for generating a control data set for controlling a print head in drop-based additive manufacturing of a component which has a wall thickness that is capable of varying over a component height, so that each layer of the component to be additively manufactured has a layer width s, wherein the control data set for each layer contains a drop spacing dT, with which drops are ejected along lines in the drop-based additive manufacturing with a drop diameter D, a line spacing dL, which indicates a spacing of the lines, and a layer height dZ, the method comprising the steps:
a) calculating a theoretical number xₜₕ of paths from a quotient between the layer width s and a predetermined target line spacing dL_{O} using
$${x}_{th} = \frac{s}{{dL}_{O}} ,$$
followed by rounding up the value xₜₕ to a next higher natural number to obtain a rounded-up number x_{auf}, and rounding down a value of the quotient to a next lower natural number, to obtain a rounded-down number x_{ab};
b) calculating a first data set of line spacing dL, drop spacing dT, and a layer thickness dZ based on the rounded-up number x_{auf},
c) calculating a second data set of line spacing dL, drop spacing dT and a layer thickness dZ based on the rounded-down number, x_{ab}, and
d) comparing the values of the first data set and the second data set with predetermined target values dL_{O}, dT_{O} and dZ_{O} depending on the component and selecting the first data set or second data set as a control data set based on the comparing.

2. The method according to claim 1, wherein the line spacing dL is calculated using
$${dL}_{suf} = \frac{s}{{x}_{suf}} ,$$
wherein suf stands for “up” for the first data set and “down” for the second data set.

3. The method according to claim 2, wherein the drop spacing is calculated using dT_{suf}=KTL−dL_{suf},
wherein kTL is a predetermined constant.

4. The method according to claim 1, wherein the layer thickness dZ is a predetermined constant value.

5. The method according to claim 3, wherein the layer thickness dZ is determined by dZ_{suf}×dT_{suf}×dL_{suf}=C,
wherein C is a predetermined constant.

6. The method according to claim 1, wherein step d) comprises:
d1) selecting a data set whose sum of amounts of deviations from the predetermined target values dL_{O}, dT_{O} and dZ_{O} is minimal.

7. The method according to claim 1, wherein the values dZ, dT, and dL are calculated as factors having absolute values obtained by multiplication with the drop diameter D.

8. The method according to claim 7, wherein the line spacing is calculated using
$${dL}_{suf} = \frac{s}{{x}_{suf}} ,$$
wherein suf stands for “up” for the first data set and “down” for the second data set,
wherein the drop spacing is calculated using dT_{suf}=kTL−dL_{suf},
wherein kTL is a predetermined constant,
wherein the layer thickness dZ is determined by dZ_{suf}×dT_{suf}×dL_{suf}=C,
wherein C is a predetermined constant, and
wherein
$$C = \frac{π}{6} .$$

9. The method according to claim 1, wherein the drop diameter D is a predetermined constant drop diameter, or
wherein the drop diameter D is variable, or
wherein the drop diameter D is variably selected from a first drop diameter and a second drop diameter differing from the first drop diameter.

10. The method according to claim 9, wherein the layer thickness dZ is calculated as a function of a variable drop diameter.

11. A method for additive layer-by-layer manufacturing of a component which has a wall thickness that is configured to vary over a component height, by dropwise application of a liquid material by a print head, the method comprising:
generating control data sets for layers of the component by the method according to claim 1; and
controlling the print head with the generated control data sets.

12. A data processing device comprising means for carrying out the method according to claim 1.

13. A non-transitory computer readable medium comprising a computer program comprising instructions which, when executed by a computer, cause the computer to carry out the method according to claim 1.

14. A device for additive manufacturing of a component, comprising:
a print head for applying liquid material drop by drop;
a movement mechanism for a relative movement of the print head and the component to be manufactured; and,
a controller configured to control the print head, the movement mechanism, or both, to carry out the method according to claim 11.
